(19) United States
(12) Patent Application Publication
(10) Pub. No.: US 2022/0379847 A1
(43) Pub. Date: Dec. 1, 2022

(54) VEHICLE, VEHICLE CONTROL METHOD, AND STORAGE MEDIUM

(71) Applicant: TOYOTA JIDOSHA KABUSHIKI KAISHA, Aichi-ken (JP)

(72) Inventors: Teruaki HAIBARA, Ashigarakami-gun (JP); Kenji HOSHI, Gotemba-shi (JP); Masaaki SATO, Susono-shi (JP)

(21) Appl. No.: 17/751,671

(22) Filed: May 24, 2022

(30) Foreign Application Priority Data
May 28, 2021 (JP) 2021-090656

(51) Int. Cl. B60S 1/08; B60S 1/04; G07C 5/08; G07C 5/00

(52) U.S. Cl. CPC B60S 1/0896; B60S 1/043; G07C 5/0816; G07C 5/008

(57) ABSTRACT

A vehicle includes: a memory; and a processor coupled to the memory, the processor being configured to: in a case in which it has been determined that washing of the vehicle is to be carried out, transition a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.

### CROSS-REFERENCE TO RELATED APPLICATION

This application is based on and claims priority under 35 USC 119 from Japanese Patent Application No. 2021-090656 filed on May 28, 2021, the disclosure of which is incorporated by reference herein.

### BACKGROUND

### Technical Field

The present disclosure relates to a vehicle, a vehicle control method, and a non-transitory storage medium storing a vehicle control program.

### Related Art

A vehicle washing facility described in Japanese Patent Application Laid-open (JP-A) No. 2009-202746 is provided with an ETC communication device that detects that an engine of a vehicle is in an operating state or that an equipment power source of the vehicle is in an operating state, at a vicinity of a vehicle washing machine main body or a vehicle washing start position. A control device that controls the vehicle washing machine main body does not start a vehicle washing operation by the vehicle washing machine main body while a communicable signal is being output by the ETC communication device. As a result, when the engine of the vehicle or the equipment power source of the vehicle is in an operating state, washing of the vehicle is not started, and therefore, contact between the vehicle and the vehicle washing machine main body due to erroneous operation or unintentional operation by a driver is prevented.

In the technology described in JP-A No. 2009-202746, while washing of the vehicle is being carried out by the vehicle washing machine, the equipment power source of the vehicle is in a non-operating state, and equipment of the vehicle cannot be operated. For this reason, in the technology described in JP-A No. 2009-202746, equipment relating to comfort within a vehicle cabin, such as air conditioning, audio or the like, cannot be operated during vehicle washing of the vehicle, and there is room for improvement with regard to improvement in comfort during washing of the vehicle.

### SUMMARY

The present disclosure has been made in consideration of the aforementioned circumstances and provides a vehicle, a vehicle control method, and a non-transitory storage medium capable of improving comfort within a vehicle cabin during vehicle washing.

A vehicle according to a first aspect includes a control section that, in a case in which it has been determined that washing of the vehicle is to be carried out, transitions a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.

In the first aspect, when washing of the vehicle is to be carried out, the control section transitions the state of the vehicle to the vehicle washing mode. In the vehicle washing mode, the power source of the vehicle is stopped, and operation of the first equipment that displaces the movable portion of the vehicle is stopped, while operation of the second equipment that is related to comfort within the vehicle cabin of the vehicle is permitted. This enables the second equipment to be operated during washing of the vehicle and enables comfort within the vehicle cabin during vehicle washing to be improved. Further, in the vehicle washing mode, the power source of the vehicle is stopped, and operation of the first equipment is stopped, whereby occurrence of unintentional contact or the like between the vehicle and the vehicle washing device main body may be avoided.

A second aspect is the first aspect, wherein the first equipment includes at least one of: a first actuator configured to rotate an outer mirror of the vehicle; a power window device configured to raise and lower a side window of the vehicle; a wiper device configured to reciprocatingly rotate a wiper of the vehicle to wipe a wiped surface; a second actuator configured to move an emblem of the vehicle; a power window device configured to open and close a sunroof of the vehicle; a third actuator configured to open and close a refueling port or a charging port of the vehicle; a fourth actuator configured to open and close a hood of the vehicle; or a functional section of a door device that opens and closes a door of the vehicle, the functional section being configured to open and close the door automatically by operation from an exterior.

According to the second aspect, it is possible to prevent a movable portion such as an outer mirror, a side window, a wiper, an emblem or the like of the vehicle from being displaced during washing of the vehicle.

A third aspect is the first aspect or the second aspect, wherein the second equipment includes at least one of: an air conditioner that carries out air conditioning within the vehicle cabin of the vehicle; an audio device provided within the vehicle cabin of the vehicle; a television provided within the vehicle cabin of the vehicle; a video playback device provided within the vehicle cabin of the vehicle; a seat heater provided at a seat of the vehicle; a massage device provided at a seat of the vehicle; a blower device provided at a seat of the vehicle; a steering heater; a USB port power source function; or a DC 12V power source function.

According to the third aspect, by operating at least one of an air conditioner, an audio device, a television, a video playback device, a seat heater, a massage device, a blower device, a steering heater, a USB port power source function, or a DC12V power source function during washing of the vehicle, comfort within the vehicle cabin during vehicle washing may be improved.

A fourth aspect is any of the first aspect to the third aspect, wherein, when transitioning from the current mode to the vehicle washing mode, the control section carries out vehicle washing preparation processing to cause an outer mirror of the vehicle to be folded up by the first actuator configured to rotate the outer mirror, and to cause a side window of the vehicle to be closed by a power window device configured to open and close the side window.

According to the fourth aspect, it is possible to suppress occurrence of damage to an outer mirror, an inside of the vehicle cabin getting wet, or the like, accompanying washing of the vehicle.

A fifth aspect is any of the first aspect to the fourth aspect, wherein, in a case in which, after the vehicle has entered a vehicle washing location at which a vehicle washing device is installed, movement of the vehicle to a vehicle washing position at which a main body of the vehicle washing device carries out vehicle washing has been completed, the control section determines that washing of the vehicle is to be carried out and transitions the current mode to the vehicle washing mode.

According to the fifth aspect, it is possible to transition to the vehicle washing mode at an appropriate timing.

A sixth aspect is any of the first aspect to the fifth aspect, wherein, in a case in which an end of vehicle washing has been notified from the vehicle washing device, the control section ends the vehicle washing mode.

According to the sixth aspect, it is possible to end the vehicle washing mode at an appropriate timing.

A seventh aspect is a vehicle control method including: determining whether or not washing of a vehicle is to be carried out; and, in a case in which it has been determined that washing of the vehicle is to be carried out, transitioning a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.

An eighth aspect is a non-transitory storage medium storing a program executable by a processor to perform vehicle control processing, the vehicle control processing including: determining whether or not washing of a vehicle is to be carried out; and, in a case in which it has been determined that washing of the vehicle is to be carried out, transitioning a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.

The seventh aspect and the eighth aspect may achieve the same effects as the first aspect.

The present disclosure enables comfort within the vehicle cabin during vehicle washing to be improved.

### BRIEF DESCRIPTION OF THE DRAWINGS

FIG. 1 is a block diagram illustrating a schematic configuration of each of an onboard system and a vehicle washing device according to an exemplary embodiment.

FIG. 2 is a functional block diagram of a vehicle washing mode ECU.

FIG. 3 is a perspective view illustrating an outer appearance and the like of a vehicle washing device main body.

FIG. 4 is a flowchart illustrating vehicle washing mode processing executed by the vehicle washing mode ECU.

FIG. 5 is a flowchart illustrating vehicle washing processing executed by a vehicle washing device control section.

### DETAILED DESCRIPTION

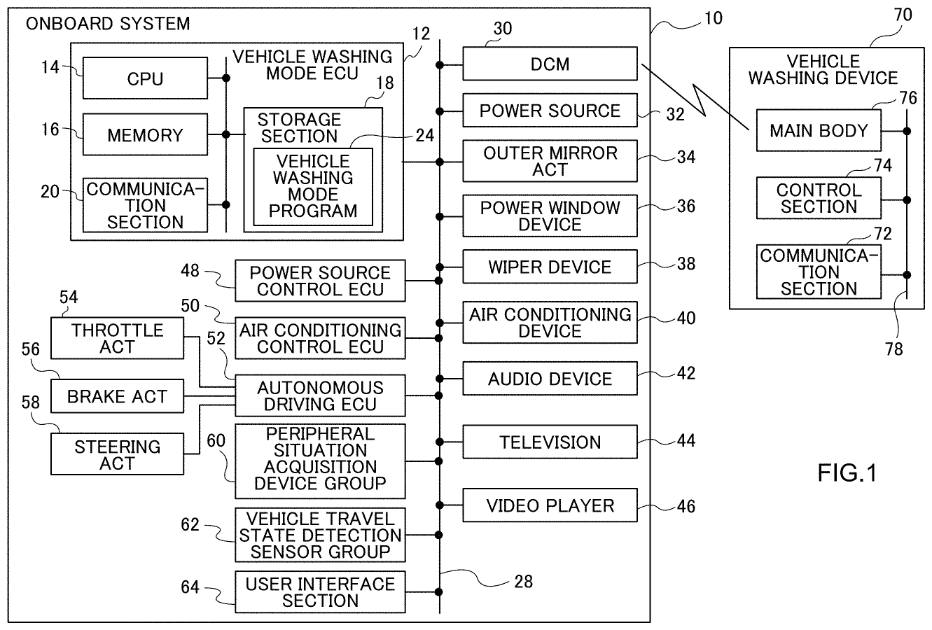

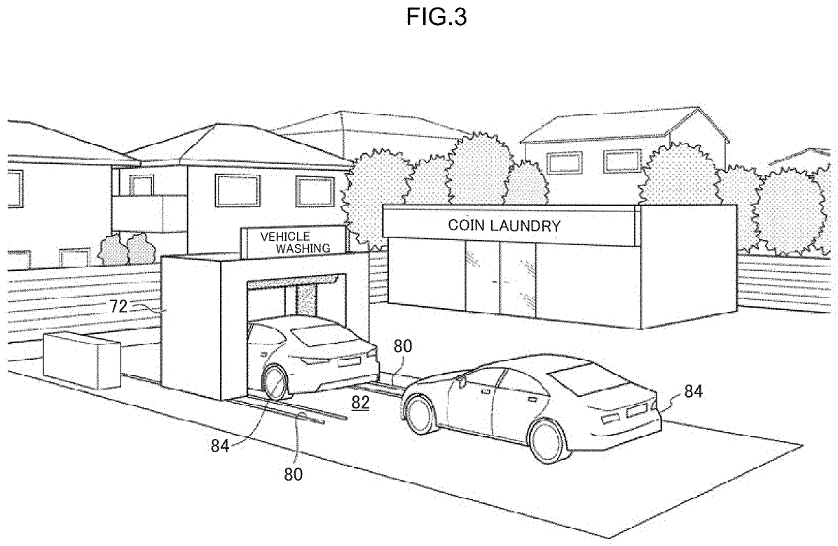

An example of an exemplary embodiment of the present disclosure will be explained in detail below with reference to the drawings. FIG. 1 illustrates an onboard system 10 and a vehicle washing device 70 that is installed at a vehicle washing location. It should be noted that FIG. 1 illustrates only a portion of the onboard system 10. Further, hereinafter, a vehicle at which the onboard system 10 is installed (an example is illustrated with the reference numeral “84” assigned thereto in FIG. 3) is referred to as a “vehicle” as necessary.

The onboard system 10 includes a vehicle washing mode ECU 12 that transitions a state of the vehicle from the current mode to a vehicle washing mode when vehicle washing of the vehicle is to be carried out by the vehicle washing device 70. The vehicle washing mode ECU 12 includes a central processing unit (CPU) 14 and a memory 16, such as a read only memory (ROM), a random access memory (RAM) or the like. Further, the vehicle washing mode ECU 12 includes a non-volatile storage section 18, such as a hard disk drive (HDD), a solid state drive (SSD) or the like, and a communication section 20.

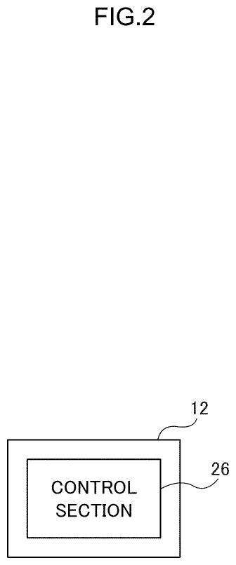

The CPU 14, the memory 16, the storage section 18 and the communication section 20 are connected so as to be capable of communicating with each other through an internal bus 22. A vehicle washing mode program 24 is stored in the storage section 18. The vehicle washing mode ECU 12 functions as a control section 26 illustrated in FIG. 2, due to the vehicle washing mode program 24 being read out from the storage section 18 and loaded in the memory 16, and the vehicle washing mode program 24 that has been loaded in the memory 16 being executed by the CPU 14.

The vehicle washing mode ECU 12 is connected to a system bus 28 of the onboard system 10. The system bus 28 is connected to a data communication module (DCM) 30 that carries out communication with an exterior of the onboard system 10, and to a power source 32 of the vehicle 84 configured by an engine or a motor. The vehicle washing mode ECU 12 is configured to be capable of communicating with the vehicle washing device 70 via the DCM 30.

Further, the system bus 28 is connected to an outer mirror actuator (ATC) 34 that is capable of rotating an outer mirror of the vehicle, to a power window device 36 that is capable of raising and lowering a side window of the vehicle, and to a wiper device 38 that is capable of reciprocatingly rotating a wiper of the vehicle to wipe a wiped surface. It should be noted that the outer mirror ACT 34, the power window device 36 and the wiper device 38 are examples of a first equipment.

Further, the system bus 28 is also connected to an air conditioning device 40 that carries out air conditioning within a vehicle cabin of the vehicle, to an audio device 42 that plays back audio such as music or the like within the vehicle cabin of the vehicle, to a television 44, and to a video player 46 that plays back video recorded on a recording medium such as a digital versatile disc (DVD) or the like. The air conditioning device 40 is an electric air conditioner that is operable even while operation of the power source 32 is stopped. It should be noted that the air conditioning device 40, the audio device 42, the television 44, and the video player 46 are examples of a second equipment, and that the video player 46 is an example of a video playback device.

Further, the system bus 28 is also connected to a power source control ECU 48 that controls operation of the power source 32, to an air conditioning control ECU 50 that controls operation of the air conditioning device 40, and to an autonomous driving ECU 52 that carries out autonomous driving of the vehicle 84. Moreover, the system bus 28 is also connected to a peripheral situation acquisition device group 60 and to a vehicle travel state detection sensor group 62.

The peripheral situation acquisition device group 60 includes, for example, a global positioning system (GPS) device, an onboard communication device, a radar device, a camera and the like, as devices that acquire information indicating what kind of situation a surrounding environment of the vehicle is in. The GPS device receives GPS signals from plural GPS satellites to measure a position of the vehicle. The onboard communication device is a communication device that carries out at least one of vehicle-to-vehicle communication with another vehicle or road-to-vehicle communication with a roadside unit.

The radar device detects objects, such as pedestrians, other vehicles and the like that are present in the surroundings of the vehicle, and acquires relative positions and relative speeds of the vehicle with respect to the detected objects. Further, based on changes in relative positions, relative speeds and the like of individual objects included in the most recent plural detection results, the radar device excludes noise, roadside objects such as guardrails, and the like from monitoring targets, and follows and monitors specific objects, such as pedestrians, other vehicles and the like, as monitoring target objects. The radar device then outputs information such as relative positions, relative speeds and the like of individual monitoring target objects. The camera captures images of the surroundings of the vehicle using plural cameras, and outputs the captured images.

Further, the vehicle travel state detection sensor group 62 includes a steering angle sensor that detects a steering angle of the vehicle, a vehicle speed sensor that detects a travel speed of the vehicle, and an acceleration sensor that detects acceleration applied to the vehicle, as plural sensors that acquire a travel state of the vehicle 84.

The autonomous driving ECU 52 is connected to a throttle ACT 54 that changes a throttle opening degree of the vehicle, a brake ACT 56 that changes a braking force generated by a braking device of the vehicle, and a steering ACT 58 that changes a steering amount by a steering device of the vehicle.

In a case in which an autonomous driving mode is selected as a driving mode of the vehicle, the autonomous driving ECU 52 carries out autonomous driving processing to cause the vehicle to travel autonomously without accompanying driving operation by an occupant of the vehicle. The autonomous driving processing is processing to determine the situation of the vehicle and the periphery thereof based on information obtained from the peripheral situation acquisition device group 60 and the vehicle travel state detection sensor group 62, and control the throttle ACT 54, the brake ACT 56, and the steering ACT 58.

Further, a user interface section 64 is connected to the system bus 28. The user interface section 64 includes various switches and displays provided at an instrument panel or the like of the vehicle, enabling a user (e.g., an occupant of the vehicle 84) to instruct activation/stopping of various equipment such as the air conditioning device 40 and the like. Further, by cooperating with a mobile terminal, such as a smartphone or the like that is possessed by the user, the user interface section 64 also enables the mobile terminal to function as an operation section of the vehicle washing device 70.

The vehicle washing device 70 includes a main body 72, a control section 74, and a communication section 76. The main body 72, the control section 74, and the communication section 76 are connected so as to be capable of communicating with each other through an internal bus 78.

As illustrated in FIG. 3, the main body 72 is gate-shaped in a front view, is guided by a pair of rails 80 laid on a floor surface, and is capable of reciprocating along the rails 80. A vehicle washing position 82 at which a vehicle serving as a vehicle washing target stops is provided between the pair of rails 80. Further, the main body 72 is provided with a brush device including plural types of brushes that brush mutually different portions of an outer surface of a vehicle positioned at the vehicle washing position 82, a drying device that blows air to dry a vehicle body surface of the vehicle, and a spray device that sprays water or the like onto the vehicle body.

The control section 74 includes a CPU, a memory such as ROM and RAM or the like, and a non-volatile storage section such as a HDD, a SSD or the like, and is capable of controlling operation of the main body 72 and of carrying out communication with the onboard system 10 via the communication section 76.

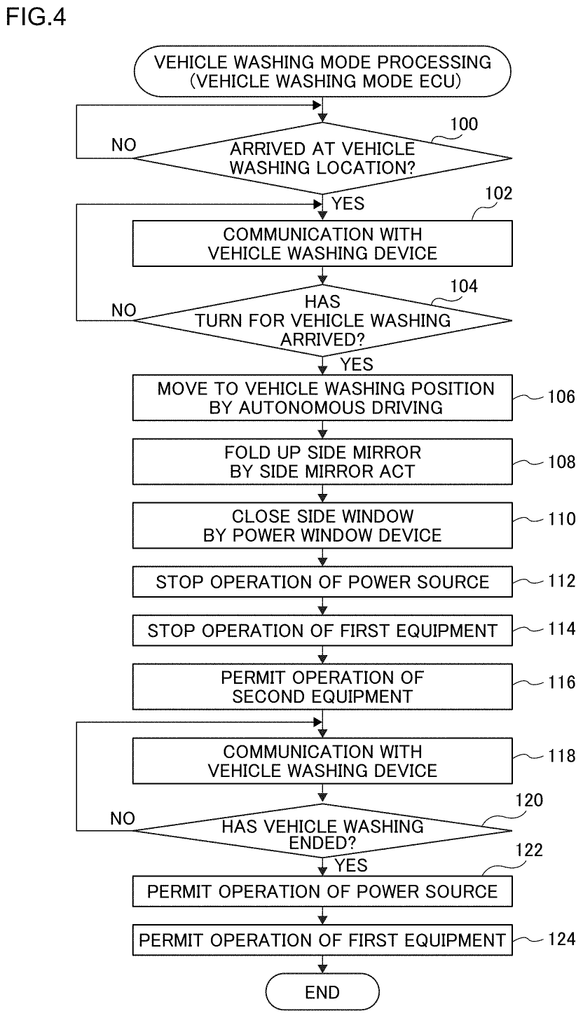

Next, explanation follows regarding operation of the present exemplary embodiment, first of all regarding vehicle washing mode processing executed by the control section 26 of the vehicle washing mode ECU 12, with reference to FIG. 4.

At step 100, the control section 26 determines whether or not the vehicle has arrived at a vehicle washing location, and repeats step 100 until the determination is affirmative. For example, in a case in which the vehicle washing location is set by the user as a destination for a non-illustrated car navigation device, and then notification is provided from the car navigation device that the vehicle has arrived at the destination (i.e., the vehicle washing location), the determination of step 100 is affirmative, and the processing transitions to step 102.

At step 102, the control section 26 carries out communication with the control section 74 of the vehicle washing device 70, and at the next step 104, based on information obtained by communicating with the control section 74, the control section 26 determines whether or not a turn for washing of the vehicle has arrived. In a case in which the determination of step 104 is negative, the processing returns to step 102, and steps 102 and 104 are repeated until the determination of step 104 is affirmative. Accordingly, the control section 26 regularly carries out communication with the control section 74, and waits until the turn for vehicle washing arrives.

When the turn for vehicle washing arrives, the determination of step 104 is affirmative, and the processing transitions to step 106. At step 106, the control section 26 instructs the autonomous driving ECU 52 to move the vehicle to the vehicle washing position 82 by autonomous driving. As a result, the vehicle is moved to the vehicle washing position 82 by autonomous driving performed by the autonomous driving ECU 52.

Further, while the vehicle is moving to the vehicle washing position 82 by autonomous driving, at the next step 108, the control section 26 controls so as to cause the outer mirror of the vehicle to be folded up (i.e., rotated to a closed position) by the outer mirror ACT 34. Further, at step 110, the control section 26 controls so as to cause the side window of the vehicle to be closed by the power window device 36. It should be noted that steps 108 and 110 are examples of vehicle washing preparation processing.

After the vehicle arrives at the vehicle washing position 82, the control section 26 carries out processing to transition the state of the vehicle to the vehicle washing mode at the next step 112 and thereafter. Namely, at step 112, the control section 26 stops operation of the power source 32 via the power source control ECU 48. Further, at step 114, the control section 26 stops operation of the first equipment, that is to say, the outer mirror ACT 34, the power window device 36, and the wiper device 38.

Further, at step 116, the control section 26 permits operation of the second equipment, that is to say, the air conditioning device 40, the audio device 42, the television 44, and the video player 46. It should be noted that, in the present exemplary embodiment, even if a user within the vehicle cabin of the vehicle 84 carries out an operation to switch an ignition switch to an ON state while the state of the vehicle 84 is in the vehicle washing mode, this operation is not accepted, and the switching to the ON state is cancelled.

This enables the user to actuate the air conditioning device 40, the audio device 42, the television 44, and the video player 46 as necessary while washing of the vehicle is being carried out by the main body 72, and therefore enables comfort within the vehicle cabin to be improved. Further, by stopping the power source 32 and stopping operation of the outer mirror ACT 34, the power window device 36, and the wiper device 38, occurrence of unintentional contact or the like between the vehicle and the main body 72 while vehicle washing is being carried out may be suppressed.

At step 118, the control section 26 carries out communication with the control section 74, and at the next step 120, based on information obtained by communicating with the control section 74, the control section 26 determines whether or not washing of the vehicle has ended. In a case in which the determination of step 120 is negative, the processing returns to step 118, and steps 118 and 120 are repeated until the determination of step 120 is affirmative.

When washing of the vehicle ends, the determination of step 120 is affirmative, and the processing transitions to step 122. At step 122 and thereafter, the control section 26 switches the state of the vehicle from the vehicle washing mode to another mode (for example, a mode in which the ignition switch is ON). Namely, at step 122, the control section 26 permits operation of the power source 32. This enables the vehicle to be moved from the vehicle washing position 82 to another position by power generated by the power source 32.

Further, at step 124, the control section 26 permits operation of the first equipment, such as the outer mirror ACT 34, the power window device 36, the wiper device 38 and the like, and ends the vehicle washing mode processing. This enables the outer mirror of the vehicle to be rotated to an open position when the vehicle is moved from the vehicle washing position 82 to another position.

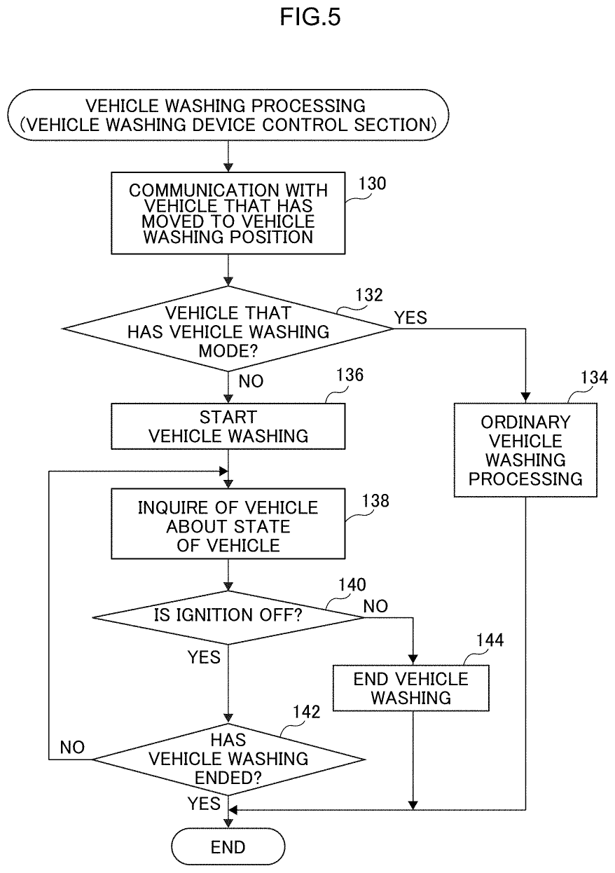

Incidentally, in the present exemplary embodiment, there is a possibility that vehicles in which the vehicle washing mode ECU 12 is not installed (i.e., vehicles that do not have the vehicle washing mode) are mixed among vehicles that are subjected to vehicle washing by the vehicle washing device 70. In a vehicle that does not have the vehicle washing mode, there is a possibility that unintentional contact or the like with the main body 72 may occur during vehicle washing by the vehicle washing device 70, due to the ignition switch being switched to the ON state and the vehicle being moved by the power source 32. Accordingly, in the present exemplary embodiment, the control section 74 carries out the vehicle washing processing illustrated in FIG. 5 while the main body 72 is carrying out washing of the vehicle.

Namely, at step 130, the control section 74 communicates with the vehicle that has moved to the vehicle washing position 82 (i.e., the target vehicle that the main body 72 is to subject to vehicle washing from that point). Then, at step 132, based on information obtained from the target vehicle through the communication at step 130, the control section 74 determines whether or not the target vehicle is a vehicle that has the vehicle washing mode (i.e., a vehicle that is carrying out the vehicle washing mode processing illustrated in FIG. 4). In a case in which the determination at step 132 is affirmative, the processing transitions to step 134, and ordinary vehicle washing processing is carried out.

On the other hand, in a case in which the target vehicle is a vehicle that does not have the vehicle washing mode, at step 136, the control section 74 causes washing of the target vehicle by the main body 72 to be started. At the next step 138, the control section 74 communicates with the vehicle that is undergoing vehicle washing to thereby inquire of the vehicle about the state of the vehicle that is undergoing vehicle washing. Then, at step 140, based on a result of inquiry about the state of the vehicle that is undergoing vehicle washing at step 138, the control section 74 determines whether or not the ignition switch of the vehicle that is undergoing vehicle washing is being maintained in an OFF state.

In a case in which the determination of step 140 is affirmative, the processing transitions to step 142, and the control section 74 determines whether or not washing of the vehicle by the main body 72 has ended. In a case in which the determination of step 142 is negative, the processing returns to step 138, and steps 138 to 142 are repeated until the determination of step 140 is negative or until the determination of step 142 is affirmative.

In a case in which the vehicle washing by the main body 72 has ended while the ignition switch of the vehicle is maintained in the OFF state, the determination of step 142 is affirmative, and the vehicle washing processing is ended. Further, in a case in which the ignition switch of the target vehicle is switched ON before the vehicle washing has ended, the determination of step 140 is negative, the processing transitions to step 144, and the vehicle washing by the main body 72 is forcibly ended. This enables occurrence of unintentional contact or the like between the vehicle and the main body 72 to be suppressed.

As described above, in the present exemplary embodiment, the vehicle 84 includes the vehicle washing mode ECU 12 that functions as the control section 26, and the control section 26 transitions the state of the vehicle 84 to the vehicle washing mode when washing of the vehicle 84 is to be carried out. In the vehicle washing mode, the power source 32 of the vehicle 84 is stopped, operation of the first equipment that is provided at the vehicle 84 and that displaces a movable portion of the vehicle 84 is stopped, and operation of the second equipment that is provided at the vehicle 84 and that includes equipment related to comfort within the vehicle cabin of the vehicle 84 is permitted. This enables the second equipment to be actuated during washing of the vehicle 84 and enables comfort within the vehicle cabin during vehicle washing to be improved. Furthermore, occurrence of unintentional contact or the like between the vehicle 84 and the main body 72 may be suppressed.

In the present exemplary embodiment, the first equipment includes at least one of the ACT 34 that is capable of rotating the outer mirror of the vehicle 84, the power window device 36 that is capable of raising and lowering the side window of the vehicle 84, or the wiper device 38 that is capable of reciprocatingly rotating the wiper of the vehicle 84 to wipe the wiped surface. This enables the movable portion, such as the outer mirror, the wiper or the like, of the vehicle 84 to be prevented from being displaced during washing of the vehicle 84.

In the present exemplary embodiment, the second equipment includes at least one of the air conditioning device 40 that carries out air conditioning within the vehicle cabin of the vehicle 84, the audio device 42, the television 44, or the video player 46 that are provided within the vehicle cabin of the vehicle 84. This enables comfort within the vehicle cabin during vehicle washing to be improved.

In the present exemplary embodiment, the control section 26 carries out vehicle washing preparation processing when transitioning to the vehicle washing mode. Namely, the outer mirror of the vehicle 84 is folded up by the ACT 34 that is capable of rotating the outer mirror, and the side window of the vehicle 84 is closed by the power window device 36 that is capable of opening and closing the side window. This makes it possible to suppress occurrence of damage to the outer mirror, the inside of the vehicle cabin getting wet, or the like, at the time of washing of the vehicle 84.

In the present exemplary embodiment, in a case in which, after the vehicle 84 has entered the vehicle washing location at which the vehicle washing device 70 is installed, movement of the vehicle 84 to the vehicle washing position 82 at which the main body 72 of the vehicle washing device 70 carries out vehicle washing has been completed, the control section 26 transitions to the vehicle washing mode. This makes it possible to transition to the vehicle washing mode at an appropriate timing.

In the present exemplary embodiment, in a case in which the end of vehicle washing has been notified from the vehicle washing device 70, the control section 26 ends the vehicle washing mode. This makes it possible to end the vehicle washing mode at an appropriate timing.

It should be noted that, in the above-described exemplary embodiment, explanation has been given regarding an aspect in which, when the state of the vehicle is transitioned to the vehicle washing mode, the vehicle washing preparation processing is carried out in which the outer mirror of the vehicle is folded up by the outer mirror ACT 34 and the side window of the vehicle is closed by the power window device 36. However, in the present disclosure, it is not required to carry out the vehicle washing preparation processing, and, for example, folding-up of the outer mirror and closing of the side window may be left to operation by the user.

Although explanation has been given, in the above-described exemplary embodiment, regarding an aspect in which the vehicle washing mode ECU 12 transitions the state of the vehicle 84 to the vehicle washing mode at a moment when the vehicle 84 has moved to the vehicle washing position 82, the present disclosure is not limited thereto. For example, when washing of the vehicle 84 is to be carried out, the vehicle washing mode ECU 12 may transition the state of the vehicle 84 to the vehicle washing mode at a moment when the user has instructed the transition to the vehicle washing mode.

In the above-described exemplary embodiment, explanation has been given regarding an aspect in which the autonomous driving ECU 52 is also installed at the vehicle 84 at which the vehicle washing mode ECU 12 is installed, and the vehicle 84 moves by autonomous driving to the vehicle washing position 82. However, the present disclosure is not limited thereto and is also applicable to a vehicle at which the autonomous driving ECU 52 is not installed (a vehicle that does not have autonomous driving functionality).

Although the outer mirror ACT 34, the power window device 36, and the wiper device 38 have been described in the above-described exemplary embodiment as one example of the first equipment of the present disclosure, the present disclosure is not limited thereto. For example, in a vehicle incorporating an actuator (second actuator) that is capable of moving an emblem of the vehicle, the second actuator may also be included in the first equipment. Further, for example, in a vehicle provided with a power window device that is capable of opening and closing a sunroof (also referred to as a moon roof) of the vehicle, this power window device may also be included in the first equipment. Furthermore, for example, in a vehicle provided with a third actuator that is capable of opening and closing a refueling port or a charging port of the vehicle, the third actuator may also be included in the first equipment. Further, for example, in a vehicle provided with a fourth actuator that is capable of opening and closing a hood of the vehicle, the fourth actuator may also be included in the first equipment. Furthermore, for example, in a vehicle provided with a functional section (hands-free auto slide door) of a door device that opens and closes a door of the vehicle, in which the functional section is capable of opening and closing the door automatically by operation from an exterior, the hands-free auto slide door may also be included in the first equipment.

Although the air conditioning device 40, the audio device 42, the television 44, and the video player 46 have been described in the above-described exemplary embodiment as one example of the second equipment of the present disclosure, the present disclosure is not limited thereto. For example, in a vehicle provided with a seat heater at a seat, the seat heater may also be included in the second equipment. Further, for example, in a vehicle provided with a massage device at a seat, the massage device may also be included in the second equipment. Furthermore, for example, in a vehicle provided with a blower device at a seat, the blower device may also be included in the second equipment. Further, for example, in a vehicle provided with a steering heater, the steering heater may also be included in the second equipment. Further, for example, in a vehicle provided with a universal serial bus (USB) port power source function, the USB port power source function may also be included in the second equipment. Furthermore, for example, in a vehicle provided with a DC 12V power source function (cigarette lighter socket power source), the DC 12V power source function may also be included in the second equipment.

In the above-described exemplary embodiment, explanation has not been given, in particular, regarding whether to stop operation or permit operation of a third equipment (such as, for example, a car navigation device or the like) that does not belong to the first equipment or the second equipment, in the vehicle washing mode. However, operation of the third equipment may be stopped in the vehicle washing mode or may be permitted in the vehicle washing mode.

What is claimed is:

1. A vehicle comprising:
a memory; and
a processor coupled to the memory, the processor being configured to:
in a case in which it has been determined that washing of the vehicle is to be carried out, transition a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.

2. The vehicle according to claim 1, wherein the first equipment includes at least one of:
a first actuator configured to rotate an outer mirror of the vehicle;
a power window device configured to raise and lower a side window of the vehicle;
a wiper device configured to reciprocatingly rotate a wiper of the vehicle to wipe a wiped surface;
a second actuator configured to move an emblem of the vehicle;
a power window device configured to open and close a sunroof of the vehicle;
a third actuator configured to open and close a refueling port or a charging port of the vehicle;
a fourth actuator configured to open and close a hood of the vehicle; or
a functional section of a door device that opens and closes a door of the vehicle, the functional section being configured to open and close the door automatically by operation from an exterior.

3. The vehicle according to claim 1, wherein the second equipment includes at least one of:
an air conditioner that carries out air conditioning within the vehicle cabin of the vehicle;
an audio device provided within the vehicle cabin of the vehicle;
a television provided within the vehicle cabin of the vehicle;
a video playback device provided within the vehicle cabin of the vehicle;
a seat heater provided at a seat of the vehicle;
a massage device provided at a seat of the vehicle;
a blower device provided at a seat of the vehicle;
a steering heater;
a USB port power source function; or
a DC 12V power source function.

4. The vehicle according to claim 1, wherein, when transitioning from the current mode to the vehicle washing mode, the processor is configured to carry out vehicle washing preparation processing to cause an outer mirror of the vehicle to be folded up by a first actuator configured to rotate the outer mirror, and to cause a side window of the vehicle to be closed by a power window device configured to open and close the side window.

5. The vehicle according to claim 1, wherein the processor is configured to, in a case in which, after the vehicle has entered a vehicle washing location at which a vehicle washing device is installed, and movement of the vehicle to a vehicle washing position at which a vehicle washing device main body of the vehicle washing device carries out vehicle washing has been completed, determine that washing of the vehicle is to be carried out and transitions the current mode to the vehicle washing mode.

6. The vehicle according to claim 1, wherein, in a case in which an end of vehicle washing has been notified from the vehicle washing device, the processor is configured to end the vehicle washing mode.

7. A vehicle control method comprising:
determining whether or not washing of a vehicle is to be carried out; and
in a case in which it has been determined that washing of the vehicle is to be carried out, transitioning a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.

8. A non-transitory storage medium storing a program executable by a processor to perform vehicle control processing, the vehicle control processing comprising:
determining whether or not washing of a vehicle is to be carried out; and
in a case in which it has been determined that washing of the vehicle is to be carried out, transitioning a state of the vehicle from a current mode to a vehicle washing mode that stops a power source of the vehicle, stops operation of a first equipment that is provided at the vehicle and that displaces a movable portion of the vehicle, and permits operation of a second equipment that is provided at the vehicle and that is related to comfort within a vehicle cabin of the vehicle.
